(19) United States
(12) Patent Application Publication
(10) Pub. No.: US 2025/0242988 A1
(43) Pub. Date: Jul. 31, 2025

(54) CONTAINER SYSTEM FOR STORING AND TRANSPORTING FOOD

(71) Applicant: ALFABIO S.R.L., Settimo Milanese (IT)

(72) Inventors: Michelangelo ANDERLINI, Milano (IT); Maria Teresa BRASSIOLO, Milano (IT)

(21) Appl. No.: 18/853,957

(22) PCT Filed: Apr. 3, 2023
(86) PCT No.: PCT/EP2023/058654

§ 371 Date: Oct. 3, 2024

(30) Foreign Application Priority Data
Apr. 5, 2022 (CH) CH000381/2022

(51) Int. Cl. B65D 77/20; B65D 1/36; B65D 1/46; B65D 65/46

(52) U.S. Cl. CPC B65D 77/2024; B65D 1/36; B65D 1/46; B65D 65/466; B65D 2565/387

(57) ABSTRACT

The scope of the invention is a single-use container system for storing and transporting foodstuffs, in particular entire menus, having two or more separate containers of the same or different volumes, preferably produced from a compostable material. Each container includes a base, side walls that are connected to the base, and an opening opposite the base through which the contents are accessible. The containers are securely connected to a common covering sheet by an upper edge such that a multi-layer structure is formed in this region. According to the invention, detachable container lids, which have the contour of the respective container openings, are provided in the covering sheet. After the container lids are removed, a skeleton of the covering sheet remains that stays connected to the container edges.

### FIELD OF THE INVENTION

The present invention relates to a container system for storing and transporting food according to the preamble of claim 1.

### PRIOR ART

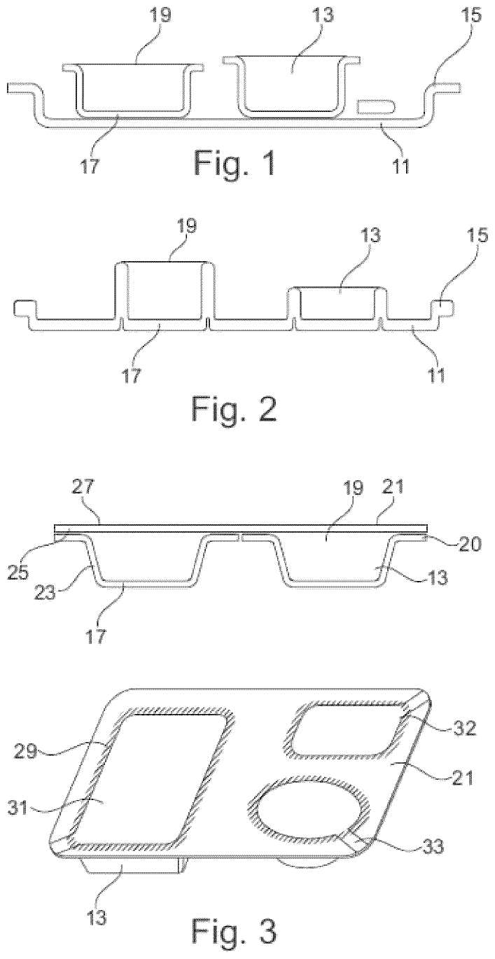

Meal trays are often used by the professional catering industry to transport and serve meals in hospitals, retirement homes and schools. The traditional tray concept consists of two main components: the tray itself and the food served in suitable containers on the tray. The tray has a load-bearing function and must therefore be sufficiently rigid and solid to carry the weight of the meal and other components such as cutlery, bread, etc. The containers placed onto the tray have the function of accommodating and storing foodstuffs; they often have to be sealed along the top to prevent contamination of the foodstuffs and to guarantee a proper condition of the foodstuffs stored therein. The two components, tray and food container, are independent of each other and are not connected to each other. This means that the tray must absorb the full weight of the meal containers (see FIG. 1).

One consequence of this is that the load-bearing tray must have a considerable thickness in order to achieve the required rigidity. Usually, load-bearing trays have a thickness between 3 and 6 mm. The load-bearing trays are generally made of durable materials such as resins, laminated wood, or durable plastics. They must be washed and sterilized/disinfected after each use.

The food containers can be made of durable (reusable) materials such as ceramics, resins, or durable plastics and must—like the load-bearing trays—also be washed and sterilized/disinfected after each use. In the recent past, reusable food containers have often been replaced by disposable food containers, which generally consist of plastic or other disposable materials. Disposable food containers have the advantage that they do not have to be washed and sterilized/disinfected after each use, but can simply be disposed of together with the food residue. In view of the reduced washing effort associated with disposable food containers, professional caterers, hospitals, clinics and school food services are also endeavoring to avoid washing the load-bearing trays to conserve water, energy, chemicals and time.

Alternative solutions in this area propose forming the load-bearing trays as a single component directly with suitable cavities of different sizes and depths (see FIG. 2) in order to combine the load-bearing function of the tray and the storage function of the food containers.

Such combined load-bearing trays/food containers, hereinafter also referred to as meal trays (MTs), can be made from thermoformable plastics, or from bagasse, wooden chips, etc. The main disadvantage of these solutions is that the load-bearing function (rigidity) and the storage function (contact with food, moisture and grease resistance, sealability) must be integrated into the entire menu tray. This requires a higher overall raw material consumption compared to the solution described above with load-bearing trays and separate food containers. High-quality materials must also be used since the entire surface of the menu tray must have the properties required for food containers. One disadvantage of this solution is that it does not offer any flexibility for food preparation since the positions and sizes of the formed cavities are determined once when the shape of the menu dish is designed.

### Objective

The object of the present invention is to propose a single-use container system intended for storing and transporting foodstuffs, in particular entire menus, having limited raw material thickness, and that is easy to dispose of and also permits flexible combinations of shapes and foods. In particular, the container set is to be heat- and deep-freeze-resistant, and in particular is to be suitable for storing, packaging, freezing, heating and/or baking foodstuffs in microwave and conventional ovens.

### Description

The present innovation relates to a single-use container system for storing and transporting foodstuffs, in particular a meal tray with two or more separate containers of the same or different volumes, preferably produced from a compostable material. Each container comprises a base, side walls that are connected to the base, and an opening opposite the base through which the contents are accessible.

The inventive container system is characterized in that the containers are securely connected by an upper edge to a common covering sheet such that a multi-layer structure is formed in this region. This creates a stable connection between the containers and the cover plate. Compared to the known serving solutions, the inventive container system differs in that the containers are arranged at the bottom of the load-bearing structure and are securely connected to the load-bearing structure formed from a covering sheet, resulting in a folded plate structure known in the construction sector for its mechanical load-bearing capacity. The folded plate structure increases the overall rigidity of the entire container system. The containers are preferably food containers and are intended to accommodate foodstuffs, wherein the foodstuffs can also be packaged.

After the container lids are removed, a skeleton of the covering sheet that stays connected to the container edges preferably remains. The container lids are preferably partial regions of the covering sheet. After the container lids are detached from the covering sheet, the regions connected to the edge of the containers remain on the covering sheet and form an inner edge of the opening in the covering sheet created by detaching the container lid. A covering sheet provided with such openings is described as a skeleton of the covering sheet. The skeleton forms the load-bearing structure present after the container lids are detached from the covering sheet. The skeleton of the covering sheet can ensure that the containers continue to be connected to the covering sheet. The covering sheet can be divided into container lids and a skeleton, wherein the container lids can be detached from the covering sheet and the skeleton then remains. The detachment between the container lids and the skeleton can be achieved by weak lines, wherein the weak lines facilitate detaching the container lids from the covering sheet or from the skeleton of the covering sheet.

In a preferred embodiment, the container system is a meal tray. The meal tray is exclusively used for accommodating, storing and transporting meals, especially entire menus. Furthermore, the container system can also be used for serving meals.

The containers preferably each have a flattened, circumferential edge of a specific width. A flattened, circumferential edge creates a contact surface to the covering sheet. Due to the flattened part of the edge, the latter has a certain width. The wider the flattened area of the edge, the larger the contact surface between the container and the covering sheet. The contact surface ensures a stronger connection between the covering sheet and the container and enhances the effect of the folded plate structure. The strength of the connection increases as the contact surface increases. In a preferred embodiment, the edge of the containers has a width between 1 and 8 mm, preferably between 2 and 6 mm, and particularly preferably between 2.5 and 5 mm.

Even if the connection strength increases as the contact surface increases, the width of the edge is preferably limited. The width of the edge and thus the contact surface occupy space in the covering sheet that cannot be used for another container. Thus, the larger the contact surface, the surface on the covering sheet occupied by a container also increases. In order to be able to offer the greatest possible leeway in the design of the container distribution in the covering sheet, the width of the edge of the containers is preferably limited.

An edge of a container is preferably at most 25 mm distant from an edge of the covering sheet. The distance is measured perpendicular to the edge of the covering sheet. A small distance between the edge of the covering sheet and a container edge results in the smallest possible area of the covering sheet while also saving materials. Another advantage is that the small distance results in increased stability of the edges of the covering sheet. This allows a user to readily grasp and lift the covering sheet at the edges. The distance between the edge of the covering sheet and the edge of a container facilitates a constant temperature along the edge of the covering sheet such that the edge of the covering sheet can be grasped by a person at any time for transporting hot or cold foods in a container.

In a preferred embodiment, the containers and the covering sheet can be heat-sealed. This permits creating a secure connection between the containers and the covering sheet in existing hot sealing machines, which are normally used to seal food shells, by applying heat and pressure.

The covering sheet advantageously serves as the lid for the containers. The task of the lid is to form a detachment between the interior of the container and the exterior region or the surroundings. This task can be achieved by the covering sheet, wherein the covering sheet would then serve as the lid of the containers. As a result, separate lids do not need to be provided for the containers, resulting in reduced overall material expenditure. The covering sheet is preferably rigid, transparent or opaque, imprinted or not imprinted and can consist of various materials that are compatible with the material of the container. If the covering sheet is rigid, it has an increased bending stiffness, wherein the covering sheet then undergoes almost no bending even with filled containers.

A transparent covering sheet can provide visual access to the interior of the containers. The foodstuffs in a container can be visually inspected without having to open the container for this purpose. An opaque covering sheet can be used to protect foodstuffs that can undergo a change if exposed to light and must therefore be protected from light. The material of the containers is preferably compatible with the material of the covering sheet. Two materials are compatible if they can jointly form a substance-to-substance connection. The connection between two materials compatible with each other requires less effort and results in a stronger connection.

The containers will generally have different contents. It can therefore be desirable to not open the containers simultaneously but one after the other. While one container is open, the other containers are still in the closed state. Preferably, detachable container lids that have the contour of the respective container openings are provided in the covering sheet. Opening a container lid then only exposes the contents of the respective container. The container lid of a container covers the entire area of the opening of this container. This means that the area of the container lid matches, or is congruent with, the open area of the container. Although detaching a container lid from the covering sheet results in the container being open, the latter nevertheless remains connected to the covering sheet with its edge. As a result, the covering sheet continues to perform its role as a load-bearing element for the containers arranged thereon even after a container lid is opened. After use, the container system exists as a contiguous unit with the remaining covering sheet and the containers arranged thereon. The secure connection of the containers by means of the covering sheet simplifies the cleanup of the container system after its use because the containers are always in the same arrangement in relation to each other and are therefore stackable into one another.

Pull-off tabs are advantageously provided on the container lids. These facilitate detaching the container lids from the covering sheet. The container lids are preferably detached with a pull-off motion. For this purpose, a first breakaway point must be introduced in the connection between the container lid and the covering sheet. The detachment is more readily propagated from this breakaway point such that the container lid is subsequently fully detached from the covering sheet. The first breakaway point can be created with the aid of a pull-off tab. Due to its simple handling, the pull-off tab represents an ideal device for starting the process of detaching the container lid.

Preferably, the pull-off tabs are provided on the lateral edge of the covering sheet. The arrangement of the pull-off tabs on the lateral edge of the covering sheet simplifies the accessibility of the pull-off tabs, which facilitates easier handling of the container set. The container lids are advantageously formed by perforations, partial perforations, incisions or half-incisions. The perforations, partial perforations, incisions or half-incisions form the circumference, and at the same time the contour, of the container lid. They assist detaching the container lid from the covering sheet with less effort and ensure that the detachment occurs along the contour. They thus form weak lines in the covering sheet that form a container lid.

The perforations and partial perforations are formed by small holes along the contour of the container lid. Continuous holes are called perforations, while discontinuous holes form a partial perforation. Although the incisions run along the contour of the covering sheet, they do not have to be formed by a straight line and can instead also extend at angles along the contour. The half-incisions are formed by two parallel, discontinuous incisions along the contour, each of which is arranged on the underside and upper side of the covering sheet. The two parallel half-incisions are connected at their ends by a slot parallel to the plane of the covering sheet.

In a further preferred embodiment, the covering sheet has openings that are substantially congruent with the openings of the containers or cover a partial region of said openings. The covering sheet can be adapted to have openings for containers whose contents do not have to be protected by a lid. For such containers, a container lid would only represent additional material and processing effort. The opening of the covering sheet can be sealed with a pull-off film. This allows sealing certain containers with a separate film. The film can thus have different properties compared to the covering sheet, wherein said properties can be important for storing the container contents.

The connection between the film and the covering sheet is preferably formed by means of a hot seal. A connection between the film and the covering sheet is created by applying a specific temperature and pressure. Hot sealing is a method frequently used in the food industry to apply a film or to create a sealed connection. Commercially available machines can thus be used by relying on a method widely used in the food industry to create the connection between the film and the covering sheet.

In a further preferred embodiment, the containers are conical or cylindrical. For a cylindrical or conical shape, the axis of rotation is arranged perpendicular to the covering sheet. Conical or cylindrical shapes have the advantage that they have a large volume with a comparatively small wall area.

Preferably, the containers each have the same height and the openings are equal to or larger than the base area. The same height of the containers permits a horizontal alignment of the covering sheet when the container set is placed onto a support surface. When the openings are equally large or larger in relation to the base area, this results in a container geometry that permits simple and direct access to all areas of the container from above. At the same time, this geometry allows containers to be stacked on top of each other, which conserves space both during production and disposal.

In a further preferred embodiment, the containers and the covering sheet are made of materials that are biodegradable and compostable. Thus, the inventive single-use container system can be disposed of by composting it together with food residue. This eliminates the need for separating or sorting between containers and food residue. Due to the use of naturally degradable materials, no waste is produced and the production and use of the inventive container set thus reduces the environmental burden. The compostability of the employed materials can be certified with a corresponding certificate.

Preferably, the base and the side walls of the containers are made of a laminate with a carrier layer made of cardboard, produced from a mechanically comminuted pulp, a single-layer or multi-layer paper, pulp or secondary fibers made of renewable and/or preferably biodegradable raw materials, and of at least one barrier layer made of a material resistant to grease, water and heat on the side facing the foodstuffs to be stored. The use of cardboard or paper is a cost-effective option. A barrier layer is provided to ensure that the containers meet the requirements with regard to hygiene and durability. Together with the barrier layer, the carton or paper forms a laminate that—owing to the barrier layer—meets the requirements for the inside of the container.

The covering sheet is preferably made of cardboard made of mechanically comminuted pulp, a single- or multi-layer paper, pulp or secondary fibers made of renewable and/or preferably biodegradable raw materials. The covering sheet advantageously comprises at least one barrier layer made of a grease-, water- and heat-resistant material on the underside of the covering sheet. In a preferred embodiment, the barrier layer can be heat-sealable such that the connection between the covering sheet and a container is created by means of the barrier layer.

The container is preferably made of cardboard or paper and has one or more barrier layers. The production of the container made of cardboard or paper is a cost-effective option and has a deep environmental burden. One or more barrier layers can add specific properties to the container that are not present in cardboard or paper. For example, these can be resistance to grease, water or heat. When using several barrier layers, each barrier layer can have a specific property. Among other things, the barrier layer can also be provided to create the connection between the covering sheet and the containers. For this purpose, the barrier layer can contain an adhesive or facilitate hot sealing.

The container and/or the covering sheet are advantageously coated on the inside with a water-based emulsion that provides resistance to grease and moisture and hot sealing properties. Coating the inside of the containers and/or the covering sheet with a water-based emulsion is an environmentally friendly and cost-effective method for achieving grease and moisture resistance.

The barrier layer preferably comprises a cellulose hydrate film. The cellulose hydrate film has the ideal properties for use in contact with food. It exhibits high resistance to water, grease, and heat and is highly compatible with foodstuffs such that foodstuffs in contact with the cellulose hydrate film are not affected negatively.

The covering sheet as well as the containers are preferably heat and cold resistant. The container set is intended to be used under different temperature conditions. The covering sheet and the containers should in this case always perform their task, which requires their resistance to heat and cold. It is also conceivable that certain containers and the respective region of the covering sheet are subject to heat, while the remaining containers and the remaining region of the covering sheet are under the influence of a cold environment. The container can preferably be used at temperatures between −80° C. and 215° C., preferably up to 175° C., and particularly preferably up to 145° C. The container comprises a heat- and cold-resistant material such that it can be used at temperatures from −80° C. to 215° C. This temperature range covers the range relevant for foodstuffs. This allows any foodstuffs to be stored in the containers. At the same time, this property underscores the ability of the inventive container set to simultaneously accommodate cold and hot foodstuffs in the containers.

The permanent connection between the lid and the containers can be generated by means of an adhesive. The adhesive is preferably suitable for contact with food and is resistant to low and high temperatures. Achieving a permanent connection by means of an adhesive can represent a simple and cost-effective manufacturing process. The adhesive may come into unintentional contact with foodstuffs when using the container set. In order to ensure safety when using the container set, it is therefore of crucial importance that the adhesive is suitable for contact with foodstuffs and does not pose a risk to foodstuffs. In addition, the connection between the covering sheet and the container must withstand low as well as high temperatures. For this reason, the adhesive is also preferably heat- and cold-resistant.

In a further preferred embodiment, the containers are imprinted. Among other things, said imprint can be used to identify the containers. Information on the contents in the container can be provided on the outside of the container. This can be useful for the user when storing or using the containers.

The covering sheet preferably has a thickness of at least 0.3 mm, preferably of at least 0.4 mm, even more preferably of at least 0.5 mm. The covering sheet forms the load-bearing structure in the inventive container system. A certain thickness of the covering sheet therefore can be preferred because this simultaneously increases the strength of the covering sheet. As a result, by increasing the thickness of the covering sheet, the rigidity

More advantageously, the covering sheet has a Taber bending moment for 15° of at least 7 mNm, preferably at least 35 mNm, in machine direction and at least 2.5 mNm, preferably at least 14 mNm, in transverse direction. The Taber bending moment for 15° is a guideline value known to a person skilled in the art for determining the bending stiffness of paper and cardboard. This involves measuring the bending moment required for deflecting a test strip by 15°. The angle between the bending line and the original alignment of the test strip increases as the bending moment exerted on the test strip increases. The Taber bending moment is reached at a deflection of 15°; it can be determined experimentally and is known in the literature for various products from the paper and cardboard industry. The two different values in the machine direction and in the transverse direction are specified because paper and cardboard are known to exhibit anisotropic behavior.

The covering sheet and the container edge together preferably have a thickness of at least 0.6 mm. This thickness of the covering sheet with the edge of the container allows a rigidity to be achieved along the edge of the container such that the thickness—in addition to the plate structure of the container with the covering sheet—also counteracts a bending of the covering sheet with the container. A rigid and stable structure is thus achieved.

The container advantageously has a constant wall thickness. A constant wall thickness of the container facilitates the production of the container and can greatly simplify estimating the material effort for producing the containers. Among other things, a constant wall thickness can be achieved if only one material is used to produce the containers and the containers are thus made of one material.

Further advantages and features of the invention result from the following description of exemplary embodiments of the invention with reference to schematic illustrations. In not-to-scale illustrations, these show in

FIG. 1: a tray with containers placed thereon;

FIG. 2: a tray having integrated containers according to the prior art;

FIG. 3: a container system comprised of a covering sheet and containers;

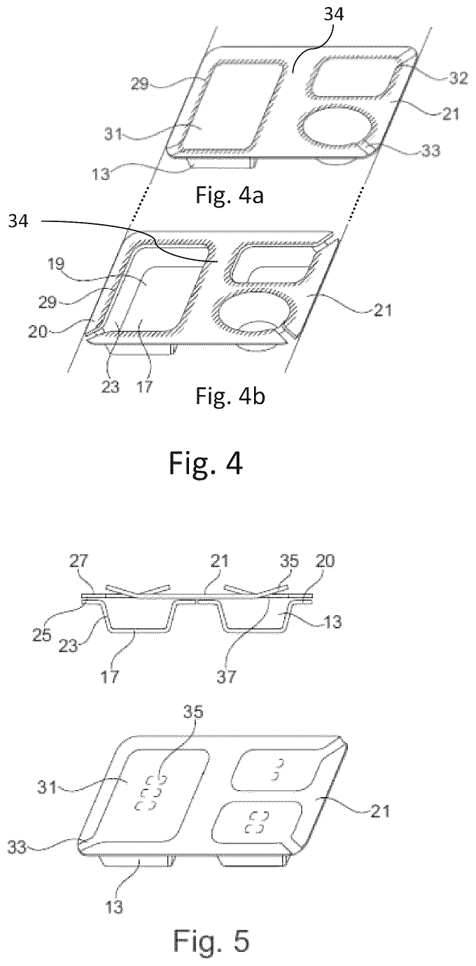

FIG. 4: a container system with a covering sheet and different containers;

FIG. 5: a container system with separate openings for the containers;

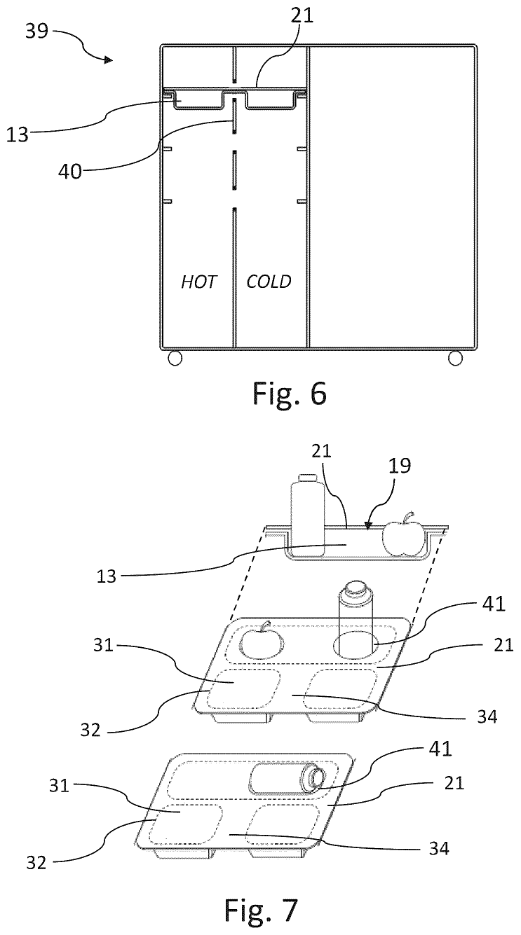

FIG. 6: a trolley with a container system placed therein;

FIG. 7: two container systems with openings in the covering sheet from which an object protrudes.

### DETAILED DESCRIPTION OF THE FIGURES

Hereinafter, the same reference symbols represent the same or functionally identical elements (in different figures). An additional apostrophe can serve to distinguish similar or functionally equivalent or functionally similar elements in a further embodiment.

FIG. 1 shows a tray 11 with separate containers 13 that are placed on the tray 11. The tray 11 facilitates the transport of the containers 13 since not all of them have to be moved individually; the containers 13 are instead transported together with the tray 11 after having been placed on the tray 11. The containers 13 can be placed on the tray 11 at arbitrary locations and can also change their position by sliding on the tray 11. An upwards projecting edge is arranged on the edges 15 of the tray 11 such that the containers 13 cannot slide off the tray 11.

The tray 11 is adapted to be grabbed and carried by a person at its edges 15. The tray 11 is preferably held or secured on two opposite edges 15. The tray 11 absorbs the weight of the containers 13 placed thereon. The rigidity of the tray 11 must be selected sufficiently high such that it does not experience any noticeable bending when transporting a loaded tray 11.

FIG. 2 shows a tray 11 comprising integrated containers 13. The containers 13 are produced simultaneously with the tray 11. The containers 13 comprise the same material as the tray 11. Partial regions of the containers 13 have a dual function and at the same time form a region of a container 13 and the tray 11. For example, the base 17 of a container 13 can simultaneously also form a region of the tray 11. Such a tray 11 can for example be produced by an injection molding process. An associated alternative embodiment not shown in the figures is formed when the opening 19 of the container is formed by an opening in the tray 11 and the container 13 is connected to the tray 11 by the edge 20 of the opening 19. Such an embodiment can be produced by molding presses and has a constant wall thickness over the tray 11 and the containers 13. The containers 13 are generated from the tray 11 by mold pressing and thus comprise the same material as the tray 11.

FIG. 3 shows an inventive container system, wherein the containers are connected to one another by means of a covering sheet 21. The containers 13 have a base 17, side walls 23 connected to the base, and an opening 19 arranged opposite the base 17. The covering sheet 21 is formed in the shape of a plate such that said covering sheet 21 extends in the two directions perpendicular to its thickness. The thickness of the covering sheet is defined by the distance between the underside 25 and the upper side 27 of the covering sheet 21. The containers 13 are arranged on the underside 25 of the covering sheet 21. The connection to the covering sheet 21 is generated on the edge 20 of the opening 19 of a container 13. The edge 20 of the container 13 is formed such that it is directed in the same direction as the base 17 of the container 13. The edge 20 is thus arranged parallel to the base 17 of the container 13 and forms an area on which the covering sheet can rest. The contact surface 29 between the covering sheet 21 and a container 13 is formed by the edge 20 of the container 13. The containers 13 can be arranged at any position, in any size and in any arrangement on the underside 25 of the covering sheet 21. A possible arrangement of the containers 13 on the covering sheet 21 is shown in FIG. 3. The latter shows that the containers 13 have different sizes and shapes, but are connected to the covering sheet 21 on their edge 20. The edge 20, which forms the contact surface 29 with the covering sheet 21, is shown as a cross-hatched surface. A multi-layer structure is created on the contact surface 29 by connecting the covering sheet 21 to a container 13 on its upper edge 20. The multi-layer structure gives the connection high strength such that it can readily withstand any directed force. Loosening this connection requires exerting a purposefully directed force.

The covering sheet 21 comprises regions 31 that come to rest above a container 13. These areas 31 are intended to be detached from the covering sheet. They can be formed by perforations, partial perforations, incision or half-incisions. The contours 32 of these regions, which form a container lid 31, lie flush with the inner edge of the upper edge 20 of the container. After the detachment and removal of a container lid 31, the container 13 continues to be connected to the covering sheet 21 on its edge 20. The perforation and partial perforation are generated by small holes along the contour 32 of the container lid 31. Continuous holes are called perforations, while discontinuous holes form a partial perforation. Although the incisions run along the contour of the container lid 31, they do not have to be formed by a straight line and can also extend at angles along the contour 32. Based on the embodiment described above, the contour 32 of the container lid 31 is formed by weak lines that quickly yield when a certain force is exerted.

FIG. 4 shows two different states of the same embodiment. The covering sheet 21 is complete in FIG. 4a, whereas the container lids 31 are removed from the covering sheet 21 in FIG. 4b. As shown in FIG. 4a, the container lid 31 can have a pull-off tab 33 on a corner or edge. This pull-off tab 33 extends beyond the shadow cast by the upper edge 20 of the container. At least after removal of the container lid 31, the upper edge 20 of the container is at said location not connected to the covering sheet 21. As can be seen in FIG. 4b, the region of the upper edge 20 of the container, over which the pull-off tab 33 is arranged, is exposed after the pull-off tab 33 is removed since the pull-off tab 33 is a part of the covering sheet 21. The pull-off tab 33 can be arranged on the edge or on the corner of the covering sheet 21. This allows a person to readily grab onto the pull-off tab 33. The pull-off tab 33 can be detached from the covering sheet 21 by exerting a relatively smaller force. The pull-off tab 33 detached from the covering sheet 21 facilitates pulling the container lid 31 off the container edge by merely overcoming the peeling force. The peeling force required to detach the container lid 31 is much smaller than the tensile force required for this purpose.

FIG. 4 shows the construction of the covering sheet 21 comprised of container lids 31 and a skeleton 34. The skeleton forms the region of the covering sheet 21 that remains after the container lid 31 has been detached from the covering sheet 21. The shape of the skeleton 34 is determined by the arrangement of the containers 13 or the container lid 31. In all embodiments, the skeleton 34 forms an integral and contiguous construct. The containers 13 are mounted by their edge on the covering sheet 21 and thus on the skeleton 34 of the covering sheet such that the containers continue to form a common composite with the skeleton 34 of the covering sheet after the container lids are removed, see FIG. 4b.

FIG. 5 shows a plan view and a perspective view of an embodiment in which the covering sheet 21 comprises further tabs 35. These tabs 35 are arranged in container lids 31, i.e. at those locations that come to rest above a container 13. These tabs 35 can be deflected and then form a ventilation opening 37 in the container lid 31. A metabolic process can thus take place between the interior of a container 13 and the exterior. This is of great importance, for example, when heating a container 13, since the density of the heated air in the container is reduced and the heated air requires more space due to the expansion. The pressure in the container 13 can be maintained at a desired level by allowing the heated air to escape through the ventilation openings 37 in the container lid 31. Since this function does not always have to be used, the ventilation openings 37 can be opened and closed with the aforementioned tabs 35. This process of opening and closing these ventilation openings 37 can preferably be repeated as often as desired. It is conceivable that said ventilation openings 37 are also used for other purposes.

FIG. 6 shows a trolley 39 that is used to accommodate trays or inventive container sets. In the inventive container system, the covering sheet 21 forms the load-bearing structure. As already described above, the containers 13 are attached to the underside of the covering sheet 21. In the trolley 39, the covering sheet 21 is placed on two lateral supports, which absorb the weight of the entire container system. The covering sheet 21 must have such a high degree of rigidity that it can absorb the weight of the containers 13 and maintain the horizontal orientation on two opposite sides when the weight is positioned thereon. Two regions with different temperatures can be additionally provided in the trolley 39. The covering sheet 21 comes to lie in both regions, wherein one or more containers are accommodated in the cool regions and the remaining containers are accommodated in the warm region of the trolley. The covering sheet 21 must absorb the thermal stresses resulting from the temperature difference. The material of the covering sheet 21 preferably has a deep thermal conductivity such that practically no heat flow takes place through the covering sheet 21. The trolley has an intermediate wall 40 that separates the warm region from the cold region. The intermediate wall 40 comprises slots that are approximately at the height of the lateral supports. A tray is placed into the trolley by inserting the tray into the slot in the intermediate wall 40. At the same time, the tray comes to rest on the lateral supports.

The embodiments in FIG. 7 each show a covering sheet 21, which already in the initial state has openings 41 above certain containers. These openings 41 are incorporated above those containers 13 that serve to accommodate foodstuffs or objects that in turn do not require protection by a lid surface. At the same time, this embodiment allows objects and foodstuffs to be accommodated in containers 13 of the container system that—when placed in the container 13—project upwards beyond the covering sheet 21. These openings 41 can cover the entire container opening 19 or only form a region of the container cover 31 arranged above the container 13. The container lids 31 are marked by a contour 32 around their circumference, which at the same time forms the dividing line between the container lid 31 and the remaining covering sheet 21, wherein the remaining covering sheet is formed by the skeleton 34 of the covering sheet together with the remaining container lids 31.

### EXEMPLARY EMBODIMENT

The secure connection of the covering sheet to the containers can be achieved by sealing or gluing the edges of a series of containers on the underside to a single upper plate—a carrier—that holds together all components and also serves as a lid for the containers. As soon as they are connected to each other as described, the covering sheet and the containers combine their structural mechanical properties to give the innovative meal tray rigidity, wherein the thickness of both components is limited. The possible combination of different shapes and sizes of containers with the corresponding covering sheet makes the food tray flexible in its configuration. Each container forms an independent unit once it is firmly connected to the covering sheet. Each cavity can be used for foodstuffs or other elements of the meal, such as cutlery, napkins, etc. Due to the limited thickness of the individual components, the structure is light, consumes fewer raw materials, is cheaper, and is easier to dispose of. If the materials selected for the containers and the covering sheet are biodegradable and compostable, the structure (innovative food tray) can be certified as compostable by virtue of the combination of both materials.

### LIST OF REFERENCE SYMBOLS

11 Tray
13 Container
15 Edges of the tray
17 Base of the container
19 Opening of the container
20 Edge of the container
21 Covering sheet
23 Side wall of the container
25 Underside of the covering sheet
27 Upper side of the covering sheet
29 Contact surface between container and covering sheet
31 Container lid
32 Contour of the container lid
33 Pull-off tab
34 Skeleton of the covering sheet
35 Tab for air vent
37 Ventilation opening
39 Trolley
40 Intermediate wall
41 Openings in the covering sheet

1.-31. (canceled)

32. A single-use container system for storing and transporting food, in particular meal trays, having two or more separate containers of the same or different volumes, wherein each container respectively comprises:
a base,
side walls connected to the base, and
an opening opposite the base,
wherein a common covering sheet is provided that is securely connected to the upper edge of the containers such that a multi-layer structure is formed in this region, wherein
the covering sheet comprises removable container lids that have the contour of the respective container openings, and
in that a skeleton of the covering sheet remains that stays connected to the container edges after the container lids are removed.

33. The container system according to claim 32, wherein the containers each have a flattened, circumferential edge of a certain width.

34. The container system according to claim 32, wherein the edge of the containers has a width between 1 and 8 mm.

35. The container system according to claim 32, wherein the containers and the covering sheet are heat-sealable.

36. The container system according to claim 32, wherein the covering sheet serves as a lid for the containers.

37. The container system according to claim 32, wherein the covering sheet is rigid, transparent or opaque, imprinted or not imprinted, and can consist of various materials that are compatible with the material of the container.

38. The container system according to claim 32, wherein pull-off tabs are provided on the container lids.

39. The container system according to claim 38, wherein the pull-off tabs are provided on the lateral edge of the covering sheet.

40. The container system according to claim 32, wherein the container lids are formed by perforations, partial perforations, incisions or half-incisions.

41. The container system according to claim 32, wherein the covering sheet comprises openings that are substantially congruent with the openings of the containers.

42. The container system according to claim 41, wherein the openings of the covering sheet can be sealed with a pull-off film.

43. The container system according to claim 42, wherein the connection between the film and the covering sheet is formed by means of a hot seal.

44. The container system according to claim 32, wherein the containers are adapted to be conical or cylindrical.

45. The container system according to claim 32, wherein the containers each have the same height and in that the openings are equal to or greater than the base surface.

46. The container system according to claim 32, wherein the containers and the covering sheet are made of materials that are biodegradable and compostable.

47. The container system according to claim 32, wherein the base and the side walls of the containers are produced from a laminate with a respective carrier layer made of cardboard produced from mechanically comminuted pulp, a single or multi-layer paper, cellulose or secondary fibers made of renewable raw materials, and at least one barrier layer made of a grease-, water- and heat-resistant material on the side facing the foodstuffs to be stored.

48. The container system according to claim 32, wherein the container is made of cardboard or paper and comprises one or more barrier layers.

49. The container system according to claim 32, wherein the container and/or the covering sheet is coated on the inside with a water-based emulsion that provides grease and moisture resistance and hot sealing properties.

50. The container system according to claim 47, wherein the barrier layer comprises a cellulose hydrate film.

51. The container system according to claim 32, wherein the covering sheet and the containers are both resistant to heat and cold.

52. The container system according to claim 32, wherein the container can be used at temperatures between −80° C. and 215° C.

53. The container system according to claim 32, wherein an adhesive is used for the secure connection of covering sheet and containers, said adhesive being suitable for contact with foodstuffs and resistant to low and high temperatures.

54. The container system according to claim 32, wherein the containers are imprinted.

55. The container system according to claim 32, wherein one of the containers comprises one or more intermediate walls.

56. The container system according to claim 32, wherein the side walls and the base of the containers are thinner than the covering sheet.

57. The container system according to claim 32, wherein the base of the container comprises depressions and/or projections to strengthen the structure.

58. The container system according to claim 32, wherein the covering sheet has a thickness of at least 0.3 mm.

59. The container system according to claim 32, wherein the covering sheet has a Taber bending moment for 15° of at least 7 mNm, in a transverse direction.

60. The container system according to claim 32, wherein the covering sheet and the container edge together have a thickness of at least 0.6 mm.

61. The container system according to claim 32, wherein the container has a constant wall thickness.

62. The container system according to claim 32, wherein the container systems can be stacked on top of one another after at least two container systems are used.
